(19) United States
(12) Patent Application Publication
(10) Pub. No.: US 2007/0200338 A1
(43) Pub. Date: Aug. 30, 2007

(54) Co-planar multi-functional document

(75) Inventors: Andre M. Saint, Getzville, NY (US); William Becker, Lockport, NY (US)

Correspondence Address: CASELLA & HESPOS, 274 MADISON AVENUE, NEW YORK, NY, 10016, US

(73) Assignee: Avery Dennison Corporation, Pasadena, CA (US)

(21) Appl. No.: 11/710,043

(22) Filed: Feb. 23, 2007

Related U.S. Application Data
(60) Provisional application No. 60/776,512, filed on Feb. 24, 2006.

(51) Int. Cl. B42D 15/00

(52) U.S. Cl. 283/105

(57) ABSTRACT

A multiple layer sheet assembly is provided with a liner having opposite inner and outer surfaces. A first face ply is formed from a first material and has an inner surface secured to a portion of the inner surface of the liner and an opposed outer surface. Die cuts extend substantially through the first face ply so that a portion of the first face ply is removable from the liner. A second face ply formed from a second material and has opposite inner and outer surfaces defining a thickness substantially equal to the thickness of the first face ply. The inner surface of the second face ply is secured to the inner surface of the liner so that the first and second face plies are in edge-to-edge relationship. Die cuts extend substantially through the second face ply to form a plurality of removable adhesive-backed labels.

This application claims priority on U.S. Provisional Patent Appl. No. 60/776,512, filed Feb. 24, 2006.

### BACKGROUND OF THE INVENTION

1. Field of the Invention

The invention relates to a multi-layer sheet assembly where different parts of one layer are formed from dissimilar materials and/or from materials that have been processed to perform different functions.

2. Description of the Related Art

Businesses and institutions frequently distribute sheet material to their customers, members or other associated entities. The sheet material may be distributed by mail or by hand. A properly produced sheet-like distribution should attract the attention of the recipient, should include information or components that are useful to the recipient and should be easy to use. Many such distributions will include one or more components that can be separated from the remainder of the sheet material and used independently of the remainder of the sheet material. For example, a sheet-like distribution may be the vehicle for distributing a membership card to the recipient or a name tag that may be carried by the recipient during the course of a particular event at which the sheet-like material is distributed. Other such distributions may include coupons, mailing labels or the like that can be separated from the remainder of the sheet and used by the recipient.

Some sheet-like materials should be relatively thick and durable, such as identification cards that will be used frequently over an extended period of time. An identification card ideally will be formed from or coated with plastic. Other sheet-like distributions, such as mailing labels, preferably are formed from a more flexible and less expensive paper. As a result, producers of such sheet materials typically might have to prepare several sheets to ensure that the material is printed on the appropriate substrate. Alternatively, the producer of such sheet material would print on a less than optimum substrate for at least part of the material that is being printed. For example, a thick durable plastic (Dupont or Arkwright) might be used for the entire sheet even though it is needed for only part. Alternatively, a flexible inexpensive paper might be used for an entire sheet even though part of the printed content desirably should be more durable.

Personal computers and available software can produce very creative content that then can be printed on laser printers. Commercially available laser printers typically will work reliably on sheet material with a thickness in the range of 4 mil-15 mils. However, the sheet material should be of substantially uniform thickness. Thus, a sheet that is being processed through a commercially available printer should have opposite surfaces that exhibit substantially uniform planarity across the entire sheet. Most commercially available printers will not function properly if either of the opposed surfaces of a sheet is discontinuous or non-planar across any part of the sheet.

In view of the above, it is an object of the invention to provide a multi-functional document that can be processed through a commercially available printer.

### SUMMARY OF THE INVENTION

The invention relates to a multiple web sheet assembly with a plurality of layers at least temporarily secured in face-to-face relationship with one another. At least one of the layers is formed from at least two dissimilar materials. However, the entire multi-web sheet assembly is of substantial uniform thickness across the extent of the assembly despite the use of dissimilar materials for at least one of the layers.

In a preferred embodiment, the multiple web sheet assembly includes a liner that extends continuously across the multiple web sheet assembly to define one of the opposite outer surfaces of the sheet assembly. The liner may be formed from paper or a synthetic material, such as polyester. In a preferred embodiment, the liner is a paper with a substantial uniform thickness of about 2-4 mils. One or both surfaces of the liner may be printed with appropriate indicia selected in accordance with the intended end use of the multiple web sheet assembly. A silicone release layer preferably is applied across at least part of one of the opposite surfaces of the liner. Additionally, or alternatively, an adhesive may be applied to at least part of one surface of the liner. For a convenient reference, the surface of the liner to which the silicone release layer or adhesive such as but not exclusively rubber based hot melt like HB Fuller is applied will be referred to as the top surface. The opposite surface of the liner will be referred to as the bottom surface. However, this reference to top and bottom does not imply a required gravitational orientation of this sheet assembly.

The multiple web sheet assembly further includes first and second face plies secured at least temporarily to the top surface of the liner by adhesive. The first and second face plies are of substantially equal thickness and are disposed in substantially edge-to-edge relationship on the top surface of the liner. As a result, the multiple web sheet assembly is of substantially uniform thickness and the face surfaces of the first and second face plies are substantially coplanar. However, the first and second face plies are formed from dissimilar materials. In this regard, the first face ply may be formed from a synthetic material, such as polyester. The second face ply, on the other hand, may be formed from paper. The thickness of the first and second plies will be selected in accordance with the intended end uses for the various parts of the multiple web sheet assembly. For example, the first and second face plies may have thicknesses in the range of about 6-15 mils. At least selected areas of the opposed facing surfaces of the liner and/or the face plies may have a thin coating of silicone or adhesive applied thereto to permit at least a local separation of portions of the face ply from the liner. Additionally, portions of the face plies may be formed with arrays of die cuts or perforations to permit separation of selected areas of the face ply from the liner.

Selected areas of either or both opposed surfaces of either or both of the face plies may be printed with appropriate indicia. The particular indicia will depend upon the intended end use of the various parts of the multiple web sheet assembly. For example, the first face ply may be formed from a synthetic material that is intended to exhibit sufficient durability to function as an identification card. This area of the first face ply may be imprinted with the name, address and identification number or account number. At least portions of the second face ply may be intended for use as a mailing label or return address. Hence, these portions of the second face ply may be printed with a name and address.

The top face of the liner may be imprinted with indicia at locations that register with portions of the face plies that are intended to be separated from the multiple web liner assembly. Thus, for example, the top face of the liner may be imprinted with indicia appropriate for acknowledging that the recipient of the sheet assembly has performed as intended by removing the particular part of the face ply.

Fold lines or score lines may be provided on portions of either of the face plies that are intended to be separated and used. Hence, a portion of a face ply that is separated from the liner can be folded about the fold line or score line and the adhesive on the face ply can be secured in face-to-face engagement with one another. As a result, the thickness of the folded portion of the face ply can effectively be doubled. This doubled portion of the face ply can assure a thickness that is appropriate for an identification card, membership card or the like. In addition, with the use of a low tack or dry adhesive (mega bond from National Starch) technology the face ply can be removed and used as an identification card or alike.

### BRIEF DESCRIPTION OF THE DRAWINGS

FIG. 1 is an exploded perspective view of a multiple web sheet assembly in accordance with the invention.

FIG. 2 is a perspective view showing the bottom surfaces of the face plies.

FIG. 3 is a perspective view of the assembled multiple web sheet assembly.

FIG. 4 is a side elevational view of the assembly shown in FIG. 3.

### DETAILED DESCRIPTION OF THE PREFERRED EMBODIMENT

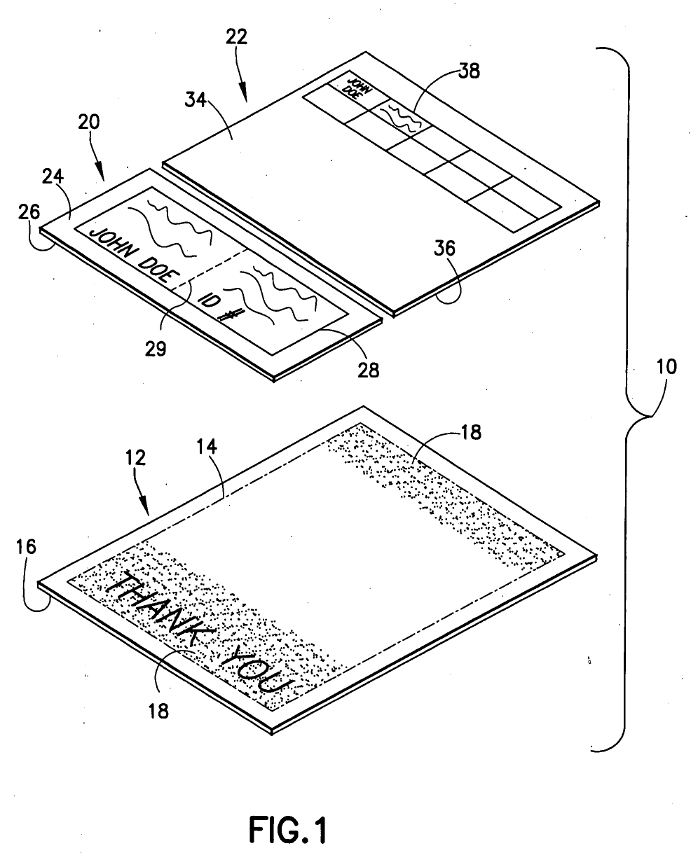

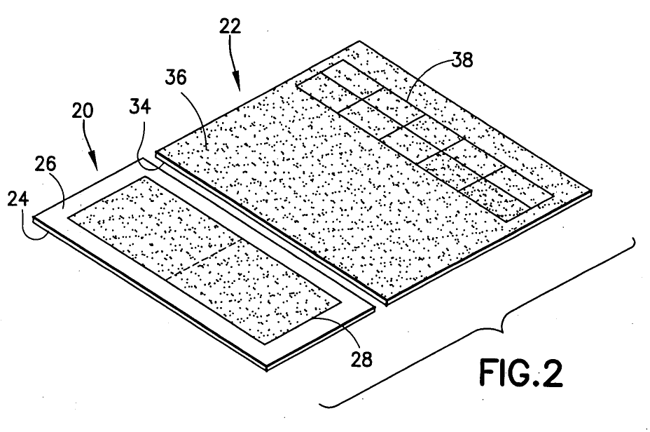

A multiple web sheet assembly in accordance with the invention is identified generally by the numeral 10 in FIGS. 1, 3 and 4. The sheet assembly 10 includes a liner 12 having a top or inner surface 14 and a bottom or outer surface 16. Indicia 17 may be printed at selected locations on the top surface 14 and/or the bottom surface 16 of the liner 12. Additionally, a thin layer of silicone 18 is applied to selected areas of the top surface 14 of the liner 12. The silicone 18 preferably is cured by exposure to UV radiation to harden. In a preferred embodiment, the liner 12 is formed from paper that has a thickness of about 2.5 mils.

The multiple web sheet assembly 10 further includes first and second face plies 20 and 22. The first face ply 20 preferably is formed from polyester and has opposite top and bottom surfaces 24 and 26 respectively defining a thickness for the first face ply of about 7.5 mils. An adhesive is applied continuously across the bottom surface 26 of the first face ply 20. Additionally, an array of die cuts or score lines 28 is formed in the first face ply 20 in areas that will overlie the siliconized area 18 of the liner 12.

The second face ply 22 is formed from paper and has opposite top and bottom surfaces 34 and 36 defining a thickness of approximately 7.5 mils. As a result, the thicknesses of the first and second face plies 20 and 22 are approximately equal to one another. Adhesive is applied continuously across the bottom surface 36 of the second face ply 22. An array of die cuts and/or score lines 38 is formed in or through areas of the second face ply, such as areas that will register with at least a portion of the silicone 18 applied to the liner 12.

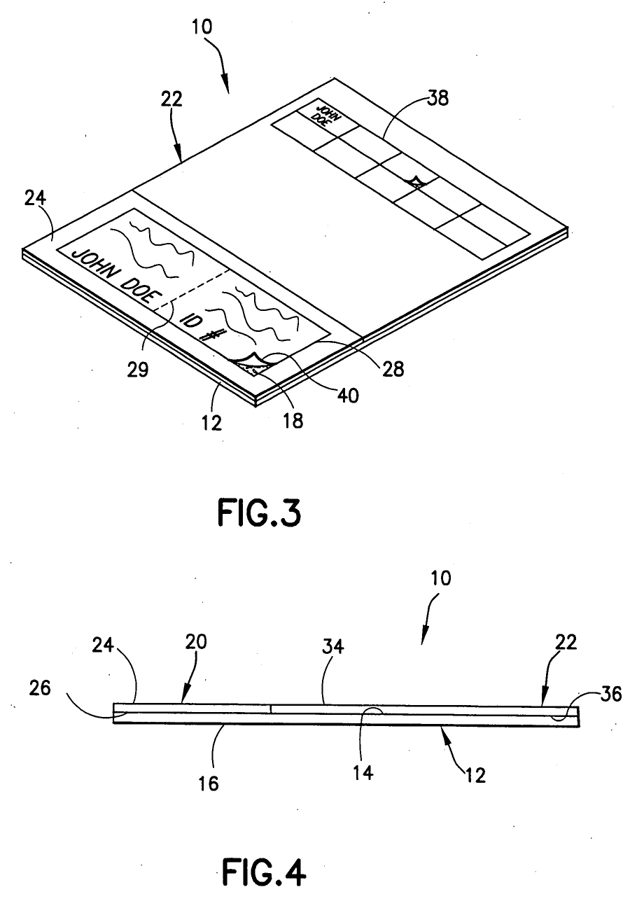

The bottom surfaces 26 and 36 of the first and second face plies 20 and 22 are secured to the top surface 14 of the liner 12 so that the first and second face plies 20 and 22 are in substantially edge-to-edge relationship, as shown in FIGS. 3 and 4. As a result, the multiple web sheet assembly 10 is of substantially uniform thickness as shown in FIG. 4. Furthermore, the top surfaces 24 and 34 of the first and second face plies 20 and 22 respectively are substantially coplanar with one another.

In the illustrated embodiment, the die cut lines 28 in the first face ply 20 register with part of the silicone 18 applied to the top surface 14 of the liner 12. The silicone 18 enables portions of the first face ply 20 bound by the die cut lines 28 to be separated from the liner 12 and from the remainder of the first face ply 20. In the illustrated embodiment, a score line 29 bisects the area bound by the die cut lines 28. Hence, the area bound by the die cuts 28 can be folded about the score line 29 so that portions of the bottom surface 26 can be secured in face-to-face relationship to one another. This configuration doubles the thickness of the card 40 removed from the first face ply 20. As noted above, the first ply 20 in the preferred embodiment has a thickness of about 7.5 mils. As a result, the folded card 40 has a thickness of about 15 mils. The first face ply 20 is formed from a polyester. The polyester card with the thickness of 15 mils can be handled easily and conveniently and provides very good durability. Both opposed surfaces of the folded card 40 can be imprinted with indicia as shown schematically in the figures, such as indicia to identify the bearer, a membership number, an account number, an address or the like.

In a similar manner, regions of the second face ply 22 bound by the die cut lines 38 substantially register with an area of the top surface 14 of the liner 12 having silicone 18 applied thereto. Hence, areas of the second face ply 22 bound by the die cut lines 38 can be separated from the liner 12 and from the remainder of the second face ply 22. These areas of the second face ply 22 bound by the die cut lines 38 can be imprinted with indicia, such as mailing addresses or return mailing addresses. Additionally, these areas of the second face ply 22 have the adhesive applied to the bottom surface 36. As noted above, the second face ply 22 preferably is formed from paper and the regions of the second face ply bound by the die cut lines 38 can function very well as mailing labels.

In accordance with the invention, a multiple web sheet assembly 10 is provided with a liner 12 and first and second face plies 20 and 22 formed from dissimilar materials. The sheet assembly 10 is of uniform thickness throughout and the opposite outer surfaces of the sheet assembly 10 are substantially coplanar. As a result, different regions of the sheet assembly 10 can be imprinted with appropriate indicia and removed selectively from remaining portions of the sheet assembly 10 for independent use. The dissimilar materials of the first and second face plies 20 and 22 enable cards, labels or the like with appropriate characteristics for an intended use. The uniform thickness and coplanarity enables the sheet assembly 10 to be printed on a commercially available printer.

While the invention has been described with respect to a preferred embodiment, it is apparent that various changes can be made without departing from the scope of the invention. For example, the thicknesses of the face plies 20 and 22 can differ significantly from the thicknesses described above with respect to the preferred embodiment. The first face ply 20 formed from polyester and having a thickness of 9 or 10 mils will not require folding as described above with respect to the preferred embodiment.

The preferred embodiment illustrates an application of adhesive to the entire bottom surfaces 26, 36 of each of the first and second face plies 20 and 22. However, the adhesive may be applied to only selected areas. Thus, for example, a card formed from the first face ply 20 and intended not to be folded in half does not require adhesive on the lower surface 26. As a result, adhesive may be applied selectively to avoid the regions bound by the die cut lines 28 that will form the card in the first face ply 20. In this regard, adhesive may be applied at least locally to the top surface 14 of the liner 12 and silicone 18 may be applied to areas of the first face ply 12 bound by the die cut 28.

The illustrated embodiments show printed indicia on the top surfaces 24 and 34 of the first and second face plies 20 and 22. However, printed indicia can be provided on the bottom surfaces 26 and/or 36 of the face plies 20, 22, particularly in areas that will not have adhesive applied thereto. Additionally, printing can be applied to the bottom surface 16 of the liner 12. Furthermore, printed indicia 17 can be applied to the top surface 14 of the liner 12, particularly in areas that will be siliconized. As a result, a recipient of the sheet assembly 10 will have an opportunity to read the additional indicia 17 on the top surface 14 of the liner 12 after removing part of the first or second face ply 20, 22 from the liner 12.

These and other variations will be apparent to a person skilled in this art.

What is claimed is:

1. A multiple web sheet assembly comprising:
a liner having opposite inner and outer surfaces;
a first face ply formed from a first material and having opposite inner and outer surfaces defining a selected thickness, the inner surface of the first face ply being secured in face-to-face relationship with a first region of the inner surface of the liner, die cuts formed substantially through the first face ply to define at least a first removable region that is selectively removable from remaining portions of the assembly; and
a second face ply formed from a second material that is different from the first material, the second face ply having opposite inner and outer surfaces defining a thickness substantially equal to the thickness of the first face ply, the inner surface of the second face ply being secured in face-to-face engagement with a portion of the inner surface of the liner so that the first and second face plies are in substantially edge-to-edge relationship die cuts extending substantially through the second face ply to define at least one second removable region that is selectively removable from remaining portions of the assembly, at least one of the inner surface of the second face ply and the inner surface of the liner corresponding to the second removable region being coated with a material to facilitate separation of the second removable region from the liner.

2. The multiple web sheet assembly of claim 1, wherein portions of the inner surface of the liner corresponding to the first and the second removable regions have coatings of silicone thereon to facilitate separation of the first and second removable regions from the liner.

3. A multiple web sheet assembly of claim 2, wherein substantially all of the inner surface of the first face ply and the inner surface of the second face ply have adhesive applied thereto for securing the first and second face plies to the liner.

4. The multiple web sheet assembly of claim 2, wherein the first removable region is substantially bisected by a score line for permitting said first removable region to be folded about the score line so that areas of the inner surface of the first removable region on opposite sides of the score line can be secured in face-to-face relationship with one another.

5. The multiple web sheet assembly of claim 4, wherein portions of the outer surface of the first face ply corresponding to the first removable region are imprinted with indicia.

6. The multiple web sheet assembly of claim 2, wherein the inner surface of the liner has indicia imprinted thereon at selected locations between the inner surface of the liner and the silicone.

7. The multiple web sheet assembly of claim 1, further comprising indicia imprinted on the outer surface of the liner.

8. The multiple web sheet assembly of claim 1, wherein the at least one second removable region comprises a plurality of second removable regions in substantially edge-to-edge relationship with one another.

9. The multiple web sheet assembly of claim 1, wherein portions of the inner surface of the first face ply corresponding to the first removable region are substantially free of adhesive.

10. The multiple web sheet assembly of claim 1, wherein the liner has a thickness in a range of about 2-4 mils.

11. The multiple web sheet assembly of claim 1, wherein the first and second face plies each have thicknesses in a range of about 6-15 mils.

12. The multiple web sheet assembly of claim 1, wherein the first material is a synthetic material and wherein the second material is paper.

13. The multiple web sheet assembly of claim 12, wherein the first material is polyester.

14. A multiple web sheet assembly comprising:
a liner having opposite inner and outer surfaces, at least portions of the outer surface of the liner being imprinted with indicia, at least one selected region of the inner surface of the liner having a layer of silicone applied thereto;
a first face ply formed from a first material and having opposite inner and outer surfaces defining a selected thickness, adhesive being applied to at least portions of the inner surface of the first face ply for securing the inner surface of the first face ply into face-to-face engagement with portions of the inner surface of the liner, die cuts extending substantially through the first face ply for defining a first removable region that can be separated from the liner, indicia being imprinted on portions of the outer surface of the first face ply including portions defining the first removable region; and
a second face ply formed from a second material different from the first material, the second face ply having an inner surface and an outer surface defining a second thickness substantially equal to the first thickness, adhesive being applied to at least portions of the inner surface of the second face ply for securing the second face ply into face-to-face engagement with a portion of the inner surface of the liner so that the first and second face plies are in substantially edge-to-edge relationship, die cuts extending substantially through portions of the second face ply for defining at least one second removable region in the second face ply that is selectively separable from remaining parts of the multiple web assembly, indicia being imprinted on portions of the outer surface of the second face ply, including portions defining the at least one second removable region.

15. The multiple web sheet assembly of claim 14, wherein the adhesive is applied to substantially all of the inner surface of the second face ply and wherein the silicone is applied to portions of the inner surface of the liner opposed to the at least one second removable region.

16. The multiple web sheet assembly of claim 14, wherein a fold line extends substantially symmetrically across the first removable region.

17. The multiple web sheet assembly of claim 16, wherein the silicone is applied to portions of the inner surface of the liner opposed to the first removable region and wherein the adhesive is on portions the inner surface of the first face ply on opposite sides of the fold line, whereby portions of the inner surface of the first face ply corresponding to the first removable region can be secured in face-to-face engagement with one another for defining a card having a thickness of substantially twice the thickness of the first face ply.

18. The multiple web sheet assembly of claim 14, wherein portions of the inner surface of the first face ply corresponding to the first removable region have no adhesive thereon.

19. The multiple web sheet assembly of claim 14, wherein the inner surface of the liner has indicia imprinted thereon in areas opposed to at least one of the first and second removable regions.

20. A multiple web sheet assembly comprising:
a liner having opposite inner and outer surfaces defining a thickness in a range of about 2-4 mils, indicia being imprinted on at least a first area of the liner and silicone being applied to the inner surface of the liner for covering at least the first area thereof and at least a second area thereof;
a first face ply formed from a synthetic material and having opposite inner and outer surfaces defining a thickness in a range of about 6-15 mils, the inner surface of the first face ply having adhesive applied thereto for securing the first face ply to portions of the inner surface of the liner, die cuts extending substantially through the first face ply for defining a foldable card overlying the first area of the inner surface of the liner, indicia being imprinted on portions of the outer surface of the first face ply corresponding to the foldable card; and
a second face ply formed from a material comprising paper and having opposite inner and outer surfaces defining a thickness substantially equal to the thickness of the first face ply, adhesive being applied to substantially all of the inner surface of the first face ply for securing the inner surface of the first face fly to the inner surface of the liner with the second face ply being in substantially edge-to-edge relationship with the first face ply, die cuts being formed substantially through the second face ply for defining a plurality of adhesive backed labels overlying the second area of the inner surface of the liner having the silicone applied thereto, portions of the outer surface of the second face ply defining the labels having indicia imprinted thereon.
